(19) United States
(12) Patent Application Publication
(10) Pub. No.: US 2021/0299655 A1
(43) Pub. Date: Sep. 30, 2021

(54) PCR CARTRIDGE

(71) Applicant: RANDOX LABORATORIES LTD, Crumlin (GB)

(72) Inventors: David Sloan, Crumlin, County Antrim (GB); Stuart Jackson, Crumlin, County Antrim (GB); John Lamont, Crumlin, County Antrim (GB); Ivan McConnell, Crumlin, County Antrim (GB); Peter Fitzgerald, Crumlin, County Antrim (GB)

(21) Appl. No.: 17/265,434

(22) PCT Filed: Aug. 2, 2019
(86) PCT No.: PCT/GB2019/052180

§ 371 Date: Feb. 2, 2021

(30) Foreign Application Priority Data
Aug. 3, 2018 (GB) 1812637.5

(51) Int. Cl. B01L 3/00

(52) U.S. Cl. CPC B01L 3/50853; B01L 3/50851; B01L 3/5453; B01L 2300/044; B01L 2200/0689; B01L 2300/123; B01L 2200/141; B01L 2300/021; B01L 2200/142; B01L 2300/0829; B01L 2300/046

(57) ABSTRACT

A cartridge for polymerase chain reaction, PCR, comprises a vessel for PCR having an opening and a resealable membrane arranged, in use, to cover the opening of the vessel such that the opening of the vessel is vapour tight.

The present invention relates to a cartridge for holding samples undergoing polymerase chain reactions.

Polymerase chain reaction (PCR) is a widely used technique for amplifying a sample of DNA or RNA to generate a large number of copies of the sample. PCR typically involves heating and cooling a low volume sample repeatedly through thermal cycling, in a temperature range of between 60 degrees centigrade (° C.) and 100° C. for up to 60 minutes. Under these conditions, the sample can evaporate and if an open container is used to hold the sample, the contents of the container would be lost before the thermal cycle is completed. Given that PCR is typically carried out on small sample quantities, typically in the tens of microliters, it is crucial that the volume of fluid lost through thermal cycling is kept to a minimum to ensure that the product contains enough amplified sample for detection.

As such, a container for holding a sample undergoing PCR must be vapour tight to reduce the risk of compromising the sample through evaporation.

One approach is to employ a reaction vessel having a lid with a tight seal, which can be opened to insert the sample before the reaction, and closed to remove the product after the reaction. However, such an approach requires the action of opening and closing the lid, which can be time consuming and labour intensive, and can lead to contamination through contact. Other approaches involve sealing the reaction vessel, with a vapour-tight foil for example, after the sample has been deposited in the vessel and before starting the PCR process. In practice, such approaches add cost and complexity to the sample preparation process and usually require a bespoke station for sealing the vessel. Significant force is required to remove or pierce the sealing to access the contents after completing the thermal cycling.

Crucially, the above approaches do not allow the contents of the reaction vessel to be accessed without compromising the vapour isolation of the vessel. The vessels must be opened and resealed each time the contents are to be accessed, which is costly and inefficient. As such, the sample cannot be adjusted or extracted without significant cost and labour.

There is therefore a need for a container for holding samples undergoing PCR which is compatible with the temperatures and conditions required for PCR thermal cycling, and which readily allows access to the contents without compromising the vapour isolation of the container.

The present invention seeks to address at least some of the above problems.

### SUMMARY OF THE INVENTION

According to a first aspect, there is provided a cartridge for polymerase chain reaction, PCR, comprising a vessel for PCR having an opening; and a resealable membrane arranged, in use, to cover the opening of the vessel such that the opening of the vessel is vapour tight.

By having a resealable membrane arranged to cover the opening of the vessel such that the opening is vapour tight, it is possible to reliably provide a container for a sample undergoing PCR without losing a significant amount of fluid through evaporation. Using the cartridge according to the first aspect, we have found that, the volume of fluid lost through PCR thermal cycling may be less than 4%. This ensures that a large enough quantity of the sample can be extracted for detection and for further analysis.

To access the contents of the cartridge, the membrane may be repairably broken or removed. Typically, the membrane is pierceable. This may be achieved by having the membrane arranged such that the membrane may be pierced by a metal or plastic pipette for example. This allows fluid to be both dispensed in to and extracted out from the vessel, simply by inserting a pipette tip, or any other suitable means, through the membrane and in to the vessel.

Whilst the membrane may be manually resealed after being pierced, typically, the membrane is self-sealing. By using a self-sealing membrane, the sample loading and extracting process is significantly simplified. For example, when conducting PCR with the cartridge, the cartridge and vessel can be provided pre-sealed and vapour-tight. The user, or an automated machine, can simply pierce a sample dispense through the membrane to insert, adjust or extract a sample. Once the sample dispenser is removed, the hole in the membrane may close due to the self-resealing property of the membrane and the cartridge may remain vapour tight. This significantly reduces the cost, complexity and bulk required during a PCR process.

An important function of the membrane in the cartridge is to provide a barrier to prevent the sample from leaving the vessel. As such, the membrane may be substantially impermeable to gas and liquid diffusion. Similar to the other components of the cartridge, the material of the membrane may be chosen according to its suitability for the high temperatures and conditions required during PCR thermal cycling. Typically, the membrane may be a thermoplastic elastomer (TPE) membrane.

The cartridge may further comprise a reinforcing part having an opening, the reinforcing part arranged, in use, to secure the membrane against the vessel such that the opening of the reinforcing part is (substantially) aligned with the opening of the vessel. The reinforcing part applies pressure to the membrane against the vessel to secure the membrane in place and reinforce a vapour tight seal at the vessel opening and reduces the likelihood of vapour passing around the membrane.

To hold the reinforcing part securely in place against the vessel and to help apply a sufficient force to the membrane and vessel, the reinforcing part may comprise a locking member arranged, in use, to engage the vessel such that the reinforcing part is locked to the vessel. By having the reinforcing part locked in place against the vessel it is possible to ensure a durable vapour-tight seal around the vessel opening. The vessel may also comprise a complementary locking member arranged, in use, to engage with the locking member of the reinforcing part, and secure the reinforcing part against the membrane and the vessel. For example, the locking member may be an interlocking clip connection. Two complementary locking members provide a secure and durable connection to hold the membrane in place over the vessel openings. As well as providing increased protection against contamination, the reinforcing part may comprise identification means, to allow the cartridge to be identified or to allow the presence of the cartridge to be detected, by an external detector. For example, markers or tags may be incorporated with the reinforcing part to allow recognition or presence sensing.

Preferably, the cartridge may further comprise a foil sealed to a surface of the reinforcing part, the foil arranged, in use, to provide a barrier across the vessel opening to protect the membrane and vessel from airborne contamination. As well as providing increased protection against contamination, the foil may comprise identification means, to allow the cartridge to be identified or to allow the presence of the cartridge to be detected, by an external detector. For example, markers or tags may be incorporated with the foil to allow recognition or presence sensing.

To allow access to the contents of the cartridge, the foil may be repairably broken or removed. Typically, the foil is pierceable. This may be achieved by having the foil arranged such that the foil may be pierced by a metal or plastic pipette for example. By having a pierceable foil and a pierceable membrane, it is possible to allow quick and easy access to the contents of the cartridge.

According to a second aspect, there is provided a cartridge for PCR comprising: a plurality of vessels for PCR, each vessel having an opening, the opening of each vessel being covered by a resealable membrane such that each covered opening is vapour tight.

A cartridge comprising a plurality of vessels allows multiple samples to undergo PCR simultaneously. The plurality of vessels may be arranged, in use, such that the samples are amplified under PCR under similar thermal conditions. Using a single cartridge to group a number of vessels can also help reduce bulk and increase operational efficiency.

Although it is useful to have multiple vessels in the same cartridge, if different samples or conditions are used, it is possible that the contents of one vessel could contaminate the contents of another. As such, the membrane may comprise a hollow boss, arranged to isolate the contents of the plurality of vessels from each other. The hollow boss may also be arranged to isolate the contents of the vessels from the environment, to further prevent spillage and/or contamination.

The cartridge may comprise a single membrane to cover the openings of one or more vessels. Alternatively, the cartridge may comprise a plurality of membranes, each covering the openings of one or more vessels. Using a plurality of membranes, it is possible to ensure the vapour tight conditions even if the integrity of one membrane is compromised.

The cartridge of the second aspect may of course use any combination of features of the first aspect as set out above and apply these features to one or more of the plurality of vessels or membranes.

### BRIEF DESCRIPTION OF THE DRAWINGS

An example cartridge will now be described by way of example with reference to the accompanying drawings, in which:

FIG. 1 schematically illustrates an exploded view of an example cartridge for PCR.

FIG. 2 schematically illustrates an exploded view of a further example cartridge for PCR.

FIG. 3 schematically illustrates the example cartridge of FIG. 2 in an assembled configuration.

FIG. 4 schematically illustrates a reinforcing part of the example cartridge of FIG. 2.

FIG. 5 schematically illustrates a membrane of the example cartridge of FIG. 2.

FIG. 6 schematically illustrates a plurality of vessels of the example cartridge of FIG. 2.

### DETAILED DESCRIPTION

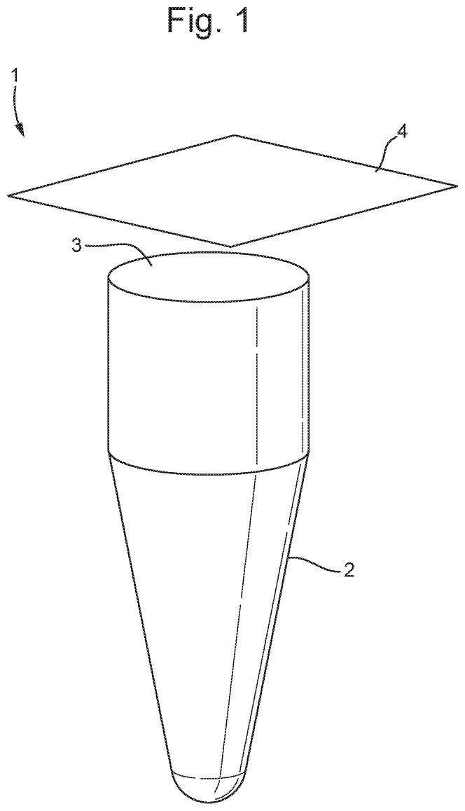

An example cartridge 1 for PCR is generally illustrated in an unassembled configuration in FIG. 1. In this example the cartridge 1 includes a vessel 2 for PCR and a resealable membrane 4. The vessel has walls extending between an opening at one end and a closed end at an opposing end, an inner volume being defined within the walls between the ends of the vessel.

The vessel 2 is arranged to contain in its inner volume a sample capable of undergoing PCR. The inner volume of the vessel 2 can be accessed through the opening 3.

In this example, the opening is substantially circular in cross-section, but the opening can be elliptical, square, rectangular or any other suitable shape. The shape of the vessel 2 itself is chosen such that dead volume during aspiration is minimised. The vessel 2 is formed from a material suitable for the high temperatures and other conditions during PCR thermal cycling. In some examples including the examples described herein, the vessel 2 is formed from a polypropylene (PP) material. Such a material is typically slightly hydrophobic, which means that, in use, when small quantities of fluid are incident on the surface of the material the fluid tends to ‘bead’, and then fall to the bottom of the vessel due to gravity.

When a fluid is aspirated from a vessel, a small volume of the fluid is retained inside the vessel due to surface tension between the fluid and the vessel inner surface, and capabilities of aspirating devices. This residual volume of fluid is known as dead volume. The shape of the vessel 2 is arranged such that dead volume during aspiration is minimised.

As described above, small quantities of fluid incident on the inner surface of the vessel 2 form beads on the inner surface of the vessel and fall to the bottom of the vessel. Minimisation of dead volume is achieved by tapering the closed end of the vessel (i.e. the bottom of the vessel) in such a way that, when fluid collects at the bottom of the vessel having a minimal volume, the upper surface of the collected fluid curves due to surface tension and the hydrophobic nature of the material from which the vessel is made, to create a convex meniscus.

In view of the surface of the fluid in the vessel being raised at the centre, when the fluid is being aspirated, for example via a pipette, the pipette tip remains immersed in the fluid for as long as possible, which helps to minimise dead volume during the aspiration.

The resealable membrane 4 is impermeable to gas and liquid diffusion. The membrane 4 may be any resealable material suitable for the conditions required during PCR thermal cycling. In this example, the membrane 4 is a thermoplastic elastomer (TPE) membrane. In use, the membrane 4 fits over the top of the vessel to cover the opening 3, such that the opening of the vessel 2 is vapour tight. In other words, the membrane 4 provides a vapour-tight seal such that when liquid or vapour material is contained in the inner volume of the vessel 2, the membrane 4 generally prevents the material from escaping the vessel 2, The membrane 4 also generally prevents liquid or gaseous material entering the vessel 2 from outside of the vessel. In this example, the membrane is self-resealing and the cartridge and vessel are provided to the user pre-sealed and vapour tight.

There are generally three main stages when conducting PCR with the cartridge disclosed herein. In an initial stage, a sample comprising nucleic acid (such as DNA or RNA) to be amplified is loaded into the cartridge. Next, the sample undergoes a PCR thermal cycling stage in which the sample and cartridge are subjected to repeated heating and cooling, and the sample nucleic acid is amplified to produce a volume of amplified nucleic acids known as amplicon, or amplimer. Lastly, the amplicon is retrieved from the cartridge for detection and further analysis.

When loading the cartridge with a sample to be amplified, a user pierces the membrane with the tip of a sample dispenser containing fluid sample. A pipette is typically used as the sample dispenser, and the membrane is pierced with a metal or plastic tip of the pipette. Sample fluid is then aspirated in to the vessel 2 and the sample dispenser tip is removed. The sample is normally prepared and loaded as a liquid solution, but the cartridge is capable of holding a solid, liquid or gas sample. Once the dispenser tip is removed, the hole in the membrane made by piercing the membrane closes due to the properties of the membrane material and the cartridge remains vapour-tight. The sample can be dispensed in the cartridge in this manner manually by a user, or by a remotely operated or automated machine. With the membrane closed and vapour tight, the cartridge is ready for PCR thermal cycling.

As the cartridge and sample undergo thermal cycling, the cartridge and sample are subjected to repeated heating and cooling through high temperatures, typically between 60° C. and 100° C. for up to 60 minutes. Due to the high temperatures during thermal cycling, vapour can be produced in the inner volume of the vessel 2. This vapour typically comprises a portion of sample vapour and a portion of amplicon vapour, and expands to fill the inner volume of the PCR vessel 2. If the cartridge did not include any means of covering the vessel opening 3, the vapour would typically escape through the opening 3 and a significant quantity of sample and/or amplicon would be lost. In the cartridge shown in FIG. 1, the membrane 4 prevents the loss of sample and amplicon by significantly restricting the diffusion of vapour out of the vessel. We have found that by using the cartridge according to the prevent invention, it is possible to achieve a vapour proof seal at the opening such that the maximum volume lost through PCR thermal cycling is suppressed to 10%. In fact, the volume of fluid lost through PCR thermal cycling is normally below 4%, leaving enough amplified sample for detection and further analysis.

After PCR thermal cycling is complete, a tip of a sample retriever is used to once again pierce the membrane and the retriever tip is pushed in to the inner volume of the vessel to access the amplicon fluid. A pipette is typically used as the sample retriever, and the membrane is pierced with a metal or plastic tip of the pipette. The sample retriever aspirates the amplicon fluid, and the tip is removed from the vessel. Once the retriever tip is removed, the hole in the membrane made by piercing the membrane once again closes over, and the cartridge remains liquid and vapour tight.

With the cartridge described herein, the stages described above can easily be repeated in part in various different sequences. For example, once the sample has been loaded to the cartridge, the sample may be partially removed or adjusted before carrying out the main PCR thermal cycle stage. In another example, additional sample may be provided to the vessel partway through a PCR thermal cycling process. Because the membrane allows the vessel to remain vapour tight, it is possible to access to the contents without compromising the vapour isolation of the container and therefore without losing a significant quantity of the sample or amplicon. The cartridge therefore provides a significantly improved flexibility in the PCR process. Furthermore, with the simple self-resealing membrane, there is no need to repeatedly open and close a lid for example to access the contents, reducing the required labour and cost.

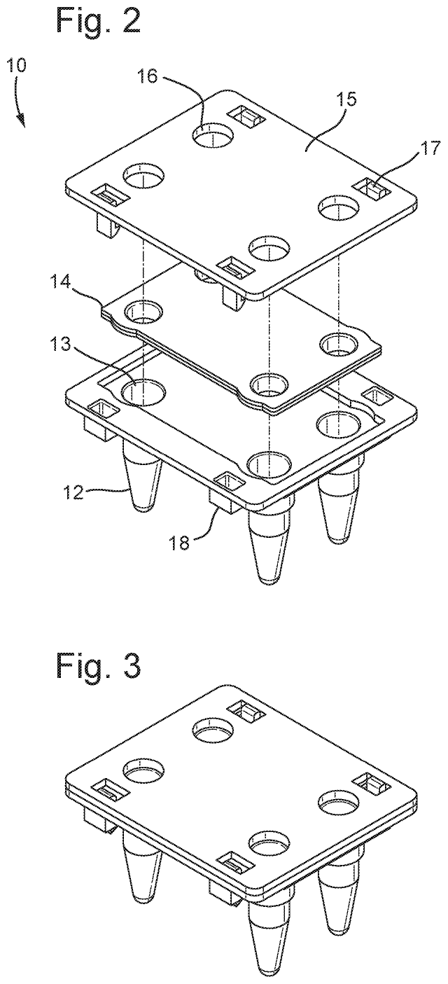

FIGS. 2 and 3 schematically illustrate a cartridge for PCR according to another example. This example cartridge is generally illustrated in an unassembled configuration in FIG. 2 and an assembled configuration in FIG. 3. In this example, the cartridge 10 comprises four vessels 12, a membrane 14 and a reinforcement part 15.

Each vessel 12 shown in the example in FIG. 2 is the same as the vessel 2 of the sample shown in FIG. 1. As such, each vessel 12 has an opening 13 and is arranged to contain in its inner volume a sample capable of undergoing PCR. The inner volume of each vessel 12 can be accessed through their respective openings 13. In this example, the openings 13 are substantially circular in cross-section, but the openings 13 can be elliptical, square, rectangular or any other suitable shape. Although FIGS. 2 and 3 depict an example having four vessels 12, the cartridge may comprise any plurality of vessels 12, each with an opening 13. As shown in FIG. 6, the bottom surface of the vessels can comprise portions or raised surface. The raised surface being arranged to interact with a complementary portion of an external device, such as a vessel holder.

The resealable membrane 14 is substantially impermeable to gas and liquid diffusion and is made from the same material as the membrane 4 of the example shown in FIG. 1, therefore having the same properties. In use, the membrane 14 fits over the top of the vessels 12 to cover the openings 13, such that each opening 13 is vapour-tight. In other words, the membrane 14 provides a vapour-tight seal such that when liquid or vapour material is contained in the inner volume of each vessel 12, the membrane 14 generally prevents the material from escaping each vessel 12. Although FIGS. 2 and 3 show the membrane comprising a single sheet of resealable membrane, in some examples the membrane 14 can be comprised of multiple smaller sheets of membrane. In some examples, each opening 13 is covered by a separate and distinct piece of resealable membrane. In the example of FIGS. 2 and 3, the membrane is self-resealing and the cartridge and vessels are provided to the user pre-sealed and vapour tight. As can be seen from the detailed view of the membrane in FIG. 5, the membrane has a plurality of hollow bosses 20. Each boss 20 is arranged to fit into the opening of one of the vessels when the cartridge is assembled. The hollow bosses 20 help to isolate the vessels 12 from each other and from the environment, in order to restrict vapour loss and contamination.

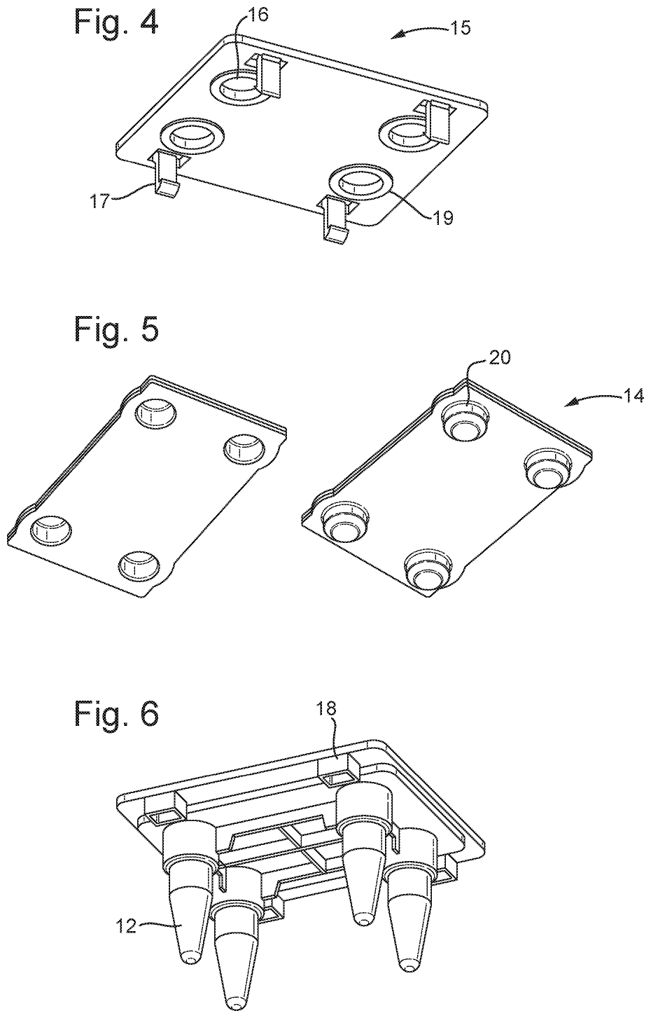

The reinforcing part 15, shown in further detail in FIG. 4, comprises four openings 16 and four locking members 17. The openings 16 of the reinforcing part 15 are substantially similar in shape and size to the vessel openings 13. In use, the reinforcing part 15 is arranged to fit on top of the vessels 12 and membrane 14 and apply a pressure against the membrane and the vessel to reinforce the seal provided by the membrane at the openings.

The openings 16 of the reinforcing part 15 are arranged such that, in use, the openings 16 of the reinforcing part 15 are substantially aligned with the openings 13 of the vessels 12. As shown in FIG. 4, the reinforcing part 15 further comprises bossed areas 19 around the edge of each of the openings 16. When the reinforcing part 15 is applied to the membrane and the vessel, the bosses 19 push down on the membrane 14 to further reinforce the seal around each vessel opening 13. This is achieved by applying compression to the membrane through the application of force to the membrane.

Each locking member 17 provides a point of contact for the reinforcing part 15 to apply a force against the membrane and the vessels, such that the reinforcing part is held firmly in place against the vessels and the membrane is further secured between the reinforcing part and the vessels 12. In some examples, the locking members 17 directly engage with one or more surfaces of the vessels 12. In the example shown in FIGS. 2 and 3, the vessels 12 are provided with complementary locking members 18. In use, each complementary locking member 18 is arranged to engage with a locking member 17 of the reinforcing part, to provide a physical coupling to secure the reinforcing part in place to apply pressure against the membrane and the vessel. In this example, the locking members 17 and complementary locking members 18 are parts of an interlocking clip connection. The clip connection can be permanent or reversible.

Although the cartridge 10 can comprise any number of locking members 17 and complementary locking members 18, typically there are equal numbers of locking members 17 and complementary locking members 18, as the two sets of locking members generally engage in pairs. This is the case in the example shown in FIGS. 2 and 3. Generally, each vessel opening 13 is provided with a locking member 17 in its proximity, to apply a pressure against the membrane 14 to maintain in use a strong vapour tight seal around each vessel opening 13.

When conducting PCR with the example cartridge 10, the process is generally similar to that described above in relation to FIG. 1. The three main stages (sample loading, PCR thermal cycling and sample retrieval), can be conducted separately or simultaneously for each of the plurality of vessels. For example, the contents of one vessel can be adjusted independently of the other vessels, while at the same time subjecting the entire cartridge to the same conditions.

1. A cartridge for polymerase chain reaction (PCR), comprising:
a vessel for PCR having an opening; and
a resealable membrane arranged, in use, to cover the opening of the vessel such that the opening of the vessel is vapour tight.

2. The cartridge according to claim 1, wherein the membrane is pierceable.

3. The cartridge according to claim 1, wherein the membrane is self-sealing.

4. The cartridge according to claim 1, further comprising a reinforcing part having an opening, the reinforcing part arranged, in use, to secure the membrane against the vessel such that the opening of the reinforcing part is substantially aligned with the opening of the vessel.

5. The cartridge according to claim 4, wherein the reinforcing part comprises a locking member arranged, in use, to engage the vessel such that the reinforcing part is locked to the vessel.

6. The cartridge according to claim 5, wherein the vessel comprises a complementary locking member arranged, in use, to engage with the locking member of the reinforcing part.

7. The cartridge according to claim 1, further comprising a foil sealed to a surface of the reinforcing part, the foil arranged, in use, to provide a barrier across the vessel opening to protect the membrane and vessel from airborne contamination.

8. The cartridge according to claim 7, wherein the foil comprises identification means, to allow the cartridge to be identified or to allow the presence of the cartridge to be detected, by an external detector.

9. A cartridge for polymerase chain reaction (PCR), comprising:
a plurality of vessels for PCR, each vessel having an opening, the opening of each vessel being covered by a resealable membrane such that each covered opening is vapour tight.

10. The cartridge according to claim 9, wherein the membrane covering the opening of each vessel is pierceable.

11. The cartridge according to claim 9, wherein the membrane covering the opening of each vessel is self-sealing.

12. The cartridge according to claim 9, further comprising a reinforcing part having a plurality of openings, the reinforcing part arranged, in use, to secure the membrane against each vessel such that the plurality of openings of the reinforcing part are substantially aligned with the openings of the vessels.

13. The cartridge according to claim 12, wherein the reinforcing part comprises one or more locking members arranged, in use, to engage the vessels such that the reinforcing part is locked to the vessels.

14. The cartridge according to claim 13, wherein one or more of the plurality of vessels each comprise a complementary locking member arranged, in use, to engage a locking member of the reinforcing part.

15. The cartridge according to claim 9, further comprising a foil sealed to a surface of the reinforcing part, the foil arranged, in use, to provide a barrier across the vessel openings to protect the membrane and vessels from airborne contamination.

16. The cartridge according to claim 15, wherein the foil comprises identification means, to allow the cartridge to be identified or to allow the presence of the cartridge to be detected, by an external detector.

17. The cartridge according to claim 9, wherein the openings of all vessels are covered by a single membrane.

18. The cartridge according to claim 9, wherein the membrane comprises hollow bossing arranged to isolate the contents of one or more vessels from each other.
